(19) United States
(12) Patent Application Publication
(10) Pub. No.: US 2026/0238601 A1
(43) Pub. Date: Aug. 13, 2026

(54) INFORMATION TRANSMISSION METHOD AND APPARATUS, COMMUNICATION DEVICE, AND STORAGE MEDIUM

(71) Applicant: Beijing Xiaomi Mobile Software Co., Ltd., Beijing (CN)

(72) Inventor: Yajun ZHU, Beijing (CN)

(73) Assignee: Beijing Xiaomi Mobile Software Co., Ltd., Beijing (CN)

(21) Appl. No.: 19/156,698

(22) PCT Filed: Feb. 15, 2023
(86) PCT No.: PCT/CN2023/076276

§ 371 Date: Aug. 14, 2025

(51) Int. Cl. H04L 47/283; H04L 5/00; H04L 43/0817

(52) U.S. Cl. CPC H04L 47/283; H04L 5/0044; H04L 43/0817

(57) ABSTRACT

A method for transmitting information, performed by a network device, includes: determining configuration information, where the configuration information is configured for multi-round-trip time measurement between a base station and a user equipment (UE) in a non-terrestrial network (NTN), and the multi-round-trip time measurement is associated with at least one downlink reference signal and at least one uplink reference signal.

### CROSS REFERENCE TO RELATED APPLICATION

The present application is a U.S. National Stage of International Application No. PCT/CN2023/076276, filed on Feb. 15, 2023, the entire contents of which are incorporated herein by reference.

### BACKGROUND OF THE INVENTION

The continuous emergence of emerging Internet applications such as new-generation augmented reality (AR)/virtual reality (VR) and vehicle-vehicle communication has put forward higher requirements for the wireless communication technology, which promotes continuous evolution of the wireless communication technology to satisfy demands of the application. Currently, cellular mobile communication technology is in an evolution stage of a new-generation technology. An important feature of the new-generation technology is to support flexible configurations of various service types. Requirements on the wireless communication technology vary with service types. For example, the main requirements of the enhanced mobile broadband (eMBB) service type focus on such aspects as large bandwidth, a high rate, etc. The main requirements of the ultra-reliable and low latency communications (URLLC) service type focus on such aspects as high reliability and low latency. The main requirements of the massive machine type communication (mMTC) service type focus on such aspects as a large number of connections. Thus, a new-generation wireless communication system needs flexible and configurable designs to support transmission for various service types.

In the research of the wireless communication technology, satellite communication is expected to play an important role in the future development of the wireless communication technology. The satellite communication is conducted by a terrestrial radio communication device with a satellite as a relay. A satellite communication system includes a satellite portion and a terrestrial portion. The satellite communication features a wide communication range; achievable communication between any two points within a range covered by radio waves emitted by the satellite; and insusceptibility to terrestrial disasters (high reliability). The satellite communication, a supplement to a current terrestrial cellular communication system, can have the advantages as follows.

Extended coverage: for areas beyond the coverage range of the current cellular communication system or requiring high coverage costs, such as oceans, deserts, and outlying mountainous areas, communication can be implemented via the satellite communication.

Emergency communication: communication connection can be rapidly established via the satellite communication in extreme situations where disasters such as earthquakes occur to render cellular communication infrastructures unavailable.

Industry application provision: for example, for latency-sensitive services with long-distance transmission, the latency of service transmission can be reduced by the satellite communication.

It can be predicted that in the future wireless communication system, the satellite communication system and the terrestrial cellular communication system will be gradually deeply fused, and thus Internet of Everything will be truly achieved.

### SUMMARY OF THE INVENTION

According to a first aspect of the embodiments of the present disclosure, a method for transmitting information is provided. The method is performed by a network device and includes: determining configuration information, where the configuration information is configured for multi-round-trip time measurement between a base station and a user equipment (UE) in a non-terrestrial network (NTN), and the multi-round-trip time measurement is associated with at least one downlink reference signal and at least one uplink reference signal.

According to a second aspect of the embodiments of the present disclosure, a method for transmitting information is provided. The method is executed by the UE and includes: receiving the configuration information transmitted by the network device, where the configuration information is configured for the multi-round-trip time measurement between the base station and the UE in the NTN, and the multi-round-trip time measurement is associated with at least one downlink reference signal and at least one uplink reference signal.

According to a third aspect of the embodiments of the present disclosure, a network device is provided. The communication device includes a processor, a transceiver, a memory, and an executable program stored in the memory and capable of being executed by the processor, where the processor, when executing the executable program, performs the method for transmitting information in the first aspect.

According to a fourth aspect of the embodiments of the present disclosure, a user equipment is provided. The communication device includes a processor, a transceiver, a memory, and an executable program stored in the memory and capable of being executed by the processor, where the processor, when executing the executable program, performs: receiving the configuration information transmitted by the network device, where the configuration information is configured for the multi-round-trip time measurement between the base station and the UE in the NTN, and the multi-round-trip time measurement is associated with at least one downlink reference signal and at least one uplink reference signal.

According to a fifth aspect of the embodiments of the present disclosure, a non-transitory computer storage medium is provided. The computer storage medium stores an executable program, where the executable program, after executed by a processor, implements the method for transmitting information in the first aspect.

According to a sixth aspect of the embodiments of the present disclosure, a non-transitory computer-readable storage medium is provided. The non-transitory computer-readable storage medium stores an executable program, where the executable program, after executed by a processor, implements the method for transmitting information in the second aspect.

For the technical solutions according to the embodiments of the present disclosure, it should be understood that the above general description and the following detailed description are merely illustrative and explanatory, and cannot limit the embodiments of the present disclosure.

### BRIEF DESCRIPTION OF DRAWINGS

The accompanying drawings here are incorporated in the description as a constituent part of the description, illustrate embodiments conforming to the present disclosure, and serve to explain the principles in the embodiments of the present disclosure along with the description.

FIG. 1 is a schematic structural diagram of a wireless communication system shown according to an example.

FIG. 2 is a schematic diagram of multi-round-trip time measurement shown according to an example.

FIG. 3 is a schematic diagram of information transmission shown according to an example.

FIG. 4 is a schematic diagram of multi-round-trip time measurement shown according to an example.

FIG. 5 is a schematic flowchart of information transmission shown according to an example.

FIG. 6 is a schematic diagram of information transmission shown according to an example.

FIG. 7 is a schematic flowchart of information transmission shown according to an example.

FIG. 8 is a schematic flowchart of information transmission shown according to an example.

FIG. 9 is a schematic flowchart of information transmission shown according to an example.

FIG. 10 is a schematic flowchart of information transmission shown according to an example.

FIG. 11 is a schematic flowchart of information transmission shown according to an example.

FIG. 12 is a schematic flowchart of information transmission shown according to an example.

FIG. 13 is a schematic flowchart of information transmission shown according to an example.

FIG. 14 is a schematic flowchart of information transmission shown according to an example.

FIG. 15 is a schematic flowchart of information transmission shown according to an example.

FIG. 16 is a schematic flowchart of information transmission shown according to an example.

FIG. 17 is a schematic flowchart of information transmission shown according to an example.

FIG. 18 is a schematic flowchart of information transmission shown according to an example.

FIG. 19 is a schematic flowchart of information transmission shown according to an example.

FIG. 20 is a schematic flowchart of information transmission shown according to an example.

FIG. 21 is a schematic structural diagram of an apparatus for transmitting information shown according to an example.

FIG. 22 is a schematic structural diagram of an apparatus for transmitting information shown according to an example.

FIG. 23 is a schematic structural diagram of UE shown according to an example.

FIG. 24 is a schematic structural diagram of a communication device shown according to an example.

### DETAILED DESCRIPTION OF THE INVENTION

Examples will be described in detail here, and illustratively shown in the accompanying drawings. When the following description relates to the accompanying drawings, the same numbers in different accompanying drawings denote the same or similar elements, unless indicated otherwise. Implementations described in the following examples do not represent all implementations consistent with the embodiments of the present disclosure. Rather, the implementations are merely instances of apparatus and methods consistent with some aspects in the embodiments of the present disclosure.

The terms used in the embodiments of the present disclosure are merely used to describe particular embodiments, rather than limit the embodiments of the present disclosure. The singular forms such as “a,” “an,” “the” and “this” used in the present disclosure are also intended to include the plural forms, unless clearly stated in the context otherwise. It should also be understood that the term “and/or” used here indicates and encompasses one or any or all possible combinations of a plurality of associated items listed.

It should be understood that the terms first, second, third, etc. may be employed in the embodiments of the present disclosure to describe various information, but should not limit the information. These terms are merely used to distinguish between the same type of information. For example, first information can alternatively be referred to as second information, and similarly, the second information can alternatively be referred to as the first information, without departing from the scope of the embodiments of the present disclosure. Depending on the context, the word “in a case where” as used here can be interpreted as “at the time of . . . ,” “when . . . ” , or “in response to determining”.

With reference to FIG. 1, a schematic structural diagram of a wireless communication system 10 according to an embodiment of the present disclosure is shown in FIG. 1. As shown in FIG. 1, the wireless communication system 10, a communication system based on the cellular mobile communication technology, may include: a plurality of UE 11 and a plurality of access devices 12.

The UE 11 may be a device providing voice and/or data connectivity for a user. The UE 11 may communicate with one or more core networks via a radio access network (RAN). The UE 11 may be UE of the Internet of Things (IoT), such as a sensor device, a mobile phone (or referred to as a “cellular” phone), and a computer with UE of the Internet of Things, for example, a stationary, portable, pocket, handheld, intra-computer, or vehicle-mounted apparatus. For example, the UE 11 is a station (STA), a subscriber unit, a subscriber station, a mobile station, a mobile, a remote station, an access point, a remote terminal, an access terminal, a user terminal, a user agent, a user device, or user equipment (UE). Alternatively, the UE 11 may be an unmanned aerial vehicle. Alternatively, the UE 11 may be a vehicle-mounted device, for example, an electronic control unit having a wireless communication function, or a wireless communication device externally connected to the electronic control unit. Alternatively, the UE 11 may be a roadside device, for example, a street lamp, signal lamp, or other roadside device etc. having a wireless communication function.

The access device 12 may be a network device in the wireless communication system 10. The wireless communication system 10 may be the 4th generation mobile communication (4G) system, which is also referred to as a long term evolution (LTE) system. Alternatively, the wireless communication system 10 may be the 5th generation mobile communication (5G) system, which is also referred to as a new radio (NR) system or a 5G NR system. Alternatively, the wireless communication system 10 may be a next generation system following the 5G system. An access network in the 5G system may be referred to a new generation-radio access network (NG-RAN), or machine-type communications (MTC) system.

The access device 12 may be an evolved node B (eNB) used in the 4G system. Alternatively, the access device 12 may be a next generation node B (gNB) using a central-distributed architecture in the 5G system. The access device 12, in a case of using the central-distributed architecture, typically includes a central unit (CU) and at least two distributed units (DUs). The CU is provided with a protocol stack of a packet data convergence protocol (PDCP) layer, a radio link control (RLC) layer, and a media access control (MAC) layer. Each DU is provided with a protocol stack of a physical (PHY) layer. The particular implementations of the access device 12 are not limited in the embodiments of the present disclosure.

The access device 12 is in wireless connection to the UE 11 via a radio interface. In different implementations, the radio interface is a radio interface based on a standard of the 4G, or the radio interface is a radio interface based on a standard of the 5G, for example, the radio interface is a new radio. Alternatively, the radio interface may be a radio interface based on a standard of the next generation mobile communication following the 5G.

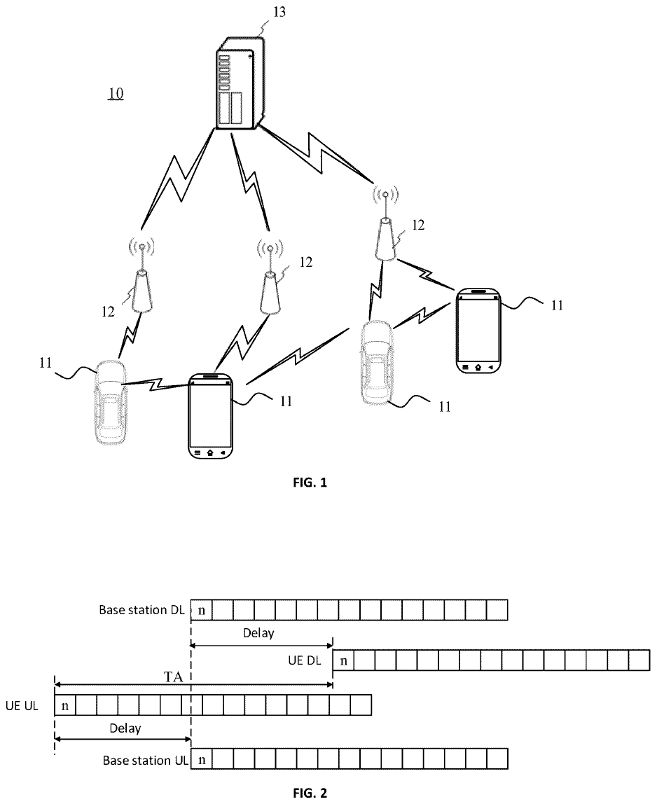

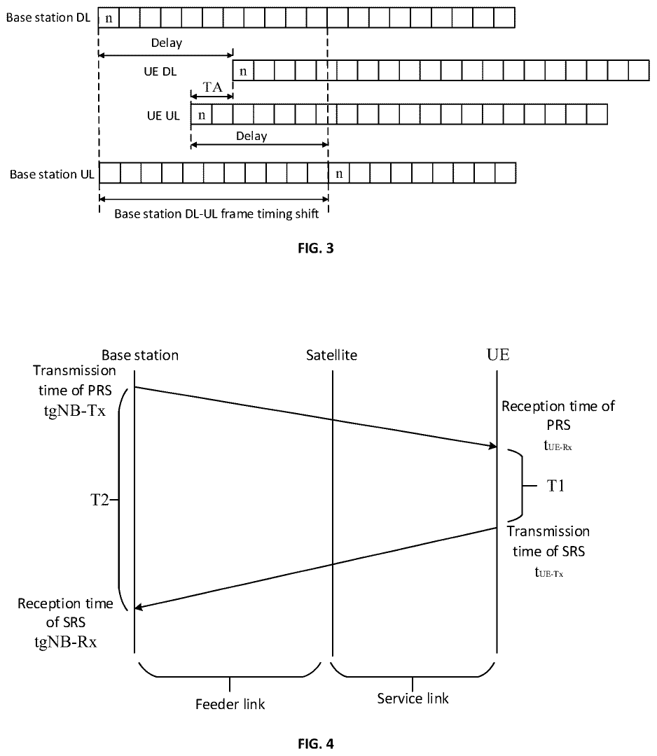

In a satellite communication system, a long propagation distance leads to a large deviation between uplink timing and downlink timing. As shown in FIGS. 2 and 3, the terminal needs to maintain uplink synchronization based on global navigation satellite system (GNSS) measurement and some auxiliary information.

For a scenario of satellite communication, long data transmission time results from a long signal transmission distance between a transmitter and a receiver. For transmission with an uplink and a downlink, it is determined in current standardization discussion that transmission latency is compensated by introducing a latency parameter. The terminal needs to report location information to enable the latency parameter to be determined.

The terminal may obtain its location information based on GNSS measurement of the terminal, and report the location information to a network side. However, for the network side, the location information obtained by the terminal based on the GNSS is unreliable. For example, the location information reported by the terminal is inaccurate; and GNSS information of the terminal is tampered with.

In one possible implementation, as shown in FIG. 4, a network device (such as a base station) may obtain the location information of the terminal by multi-round-trip time (multi-RTT). The base station may transmit a positioning reference signal (PRS) to the UE, and the UE may transmit a sounding reference signal (SRS) to the base station after receiving the PRS. The UE may report a first time interval between downlink reception and uplink transmission of the UE to the core network device (such as a location management function (LMF)). The base station may report a second time interval between downlink transmission and uplink reception of the base station to the core network device. The core network device may determine transmission duration of a signal based on the first time interval and the second time interval, and further determine relative location information of the UE.

In a process of determining the location information of the UE by the multi-RTT, it is a pressing issue for the network device to configure a required resource.

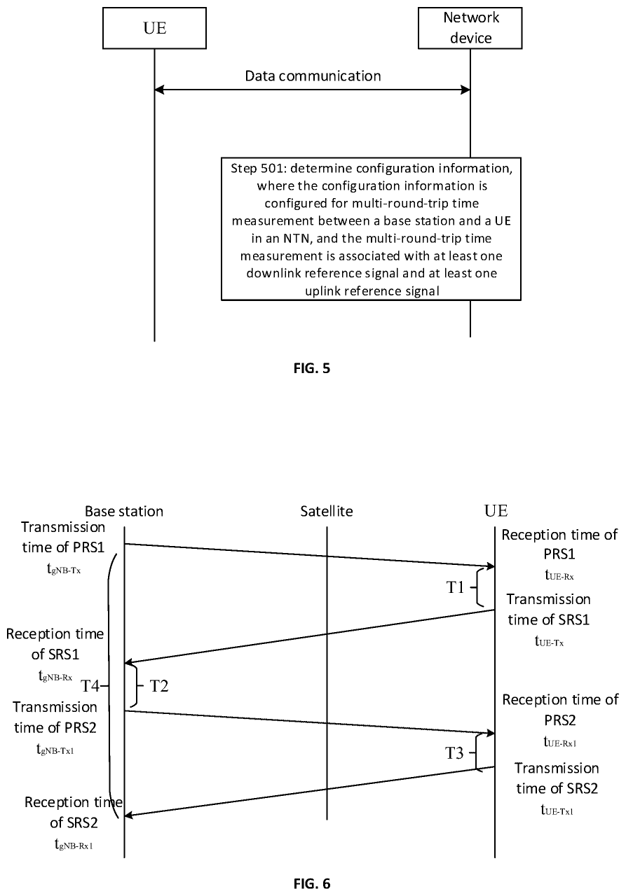

As shown in FIG. 5, a method for transmitting information is provided in the embodiments of the present disclosure. The method is performed by the network device and includes the following step 501.

In step 501, configuration information is determined, where the configuration information is configured for the multi-round-trip time measurement between the base station and the UE in the NTN, and the multi-round-trip time measurement is associated with at least one downlink reference signal and at least one uplink reference signal.

The NTN may include, but is not limited to, one of:
a communication network in which a terrestrial base station communicates with the UE via a satellite serving as a relay; or a communication network in which the satellite, serving as part of the network device (such as the base station) in a mobile communication network, communicates with the UE.

The network device here may include, but is not limited to, at least one of a core network device or an access network device (such as the base station).

The configuration information for the multi-round-trip time measurement may be determined by the core network device or the access network device.

The configuration information may be used to configure a configuration to be involved in a process of the multi-round-trip time measurement between the base station and the UE in the NTN. For example, the configuration information may indicate, but is not limited to, a transmission resource of the downlink reference signal and a transmission resource of the uplink reference signal. Thus, the base station and the UE may transmit the downlink reference signal and the uplink reference signal.

The downlink reference signal may be transmitted to the UE by the access network device. For example, the downlink reference signal may be the PRS.

The uplink reference signal may be transmitted to the access network device by the UE. For example, the uplink reference signal may be the SRS.

In the NTN, the downlink reference signal and the uplink reference signal may be forwarded by the satellite in the NTN.

In one possible implementation, the satellite in the NTN may be in a transparent forwarding mode, i.e. the satellite forwards the downlink reference signal and the uplink reference signal, without performing any decoding operation. As shown in FIG. 4, the downlink reference signal transmitted by the base station is transparently transmitted to the UE via the satellite, and the uplink reference signal transmitted by the UE is transparently transmitted to the base station via the satellite.

In one possible implementation, the satellite may be a serving satellite of the UE. The serving satellite may be a satellite associated with a serving cell of the UE.

In one possible implementation, the multi-round-trip time measurement may include at least one downlink reference signal and at least one uplink reference signal.

As shown in FIG. 4, the multi-round-trip time measurement may include one downlink reference signal and one uplink reference signal. The network device may determine round-trip time of the reference signal based on T1 (a time interval from reception of the downlink reference signal by the UE to transmission of the uplink reference signal from the UE) and T2 (a time interval from transmission of the downlink reference signal from the base station to reception of the uplink reference signal by the base station).

The multi-round-trip time measurement may include a plurality of downlink reference signals and a plurality of uplink reference signals. As shown in FIG. 6, with the multi-round-trip time measurement including two downlink reference signals and two uplink reference signals as an example, the network device may determine the round-trip time of the reference signal based on T1 (a time interval from reception of a PRS1 by the UE to transmission of an SRS1 from the UE), T2 (a time interval from reception of the SRS1 by the base station to transmission of a PRS2 from the base station), T3 (a time interval from reception of the PRS2 by the UE to transmission of an SRS2 from the UE), and T4 (a time interval from transmission of the PRS1 from the base station to reception of the SRS2 by the base station). The network device may determine round-trip times of two round trips of the reference signal: RTT1 and RTT2. The plurality of downlink reference signals and the plurality of uplink reference signals may be deduced by analogy, which will not be repeated here.

In one possible implementation, the core network device may calculate the round-trip time of the reference signal, and determine a location of the UE.

In one possible implementation, the base station and the UE may report measurement results to the core network device, and the core network device may determine the location of the UE.

In one possible implementation, the UE may report a measurement result to the base station, and the base station may report a measurement result to the core network device. The measurement result may be determined according to the measurement result of the terminal and the measurement result of the base station. The core network device determines the location of the UE.

In one possible implementation, the satellite in the NTN may be or is in a regenerative mode, i.e. the satellite may have some or all functions of the network device, and may process data from the network side or the terminal. For example, the base station may be located on the satellite directly. Thus, the downlink reference signal and the uplink reference signal may be signals transmitted between the satellite and the UE.

In one possible implementation, the network device may configure one or more satellites to participate in the multi-round-trip time measurement between the base station and the UE. The configuration information may be associated with one or more satellites.

The satellite here may be located on different orbits, including, but not limited to, one of: a geostationary earth orbit (GEO); a medium earth orbit (MEO); or a low earth orbit (LEO).

The network device may determine the configuration information based on at least one of: orbital altitude information of the serving satellite; availability of the transmission resource; a load of the base station; a load of the UE; or a load of the satellite.

The network device determines the configuration information. Thus, the demand for the multi-round-trip time measurement between the base station and the UE in the NTN is satisfied, and a success rate of the multi-round-trip time measurement is increased.

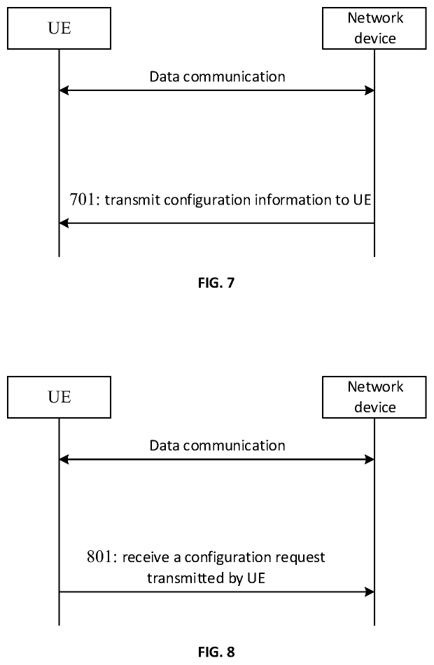

As shown in FIG. 7, a method for transmitting information is provided in the embodiments of the present disclosure. The method is performed by the network device and includes the following step 701.

In step 701, configuration information is transmitted to the UE.

In one possible implementation, in a case where the network device is the access network device, the base station may transmit the configuration information to the UE.

In one possible implementation, in a case where the network device is a core network device, the core network device may transmit the configuration information to the UE via the access network device.

In one embodiment, the configuration information is configured to indicate at least one of: an identity of the satellite associated with the multi-round-trip time measurement; an ephemeris of the satellite; timing of the satellite; a configuration of the uplink reference signal; a configuration of the downlink reference signal; or a configuration of reporting, by the UE, a first measurement result associated with the multi-round-trip time measurement to the network device.

The identity of the satellite may be configured to uniquely identify the satellite. The configuration information may indicate the satellite participating in the multi-round-trip time measurement between the base station and the UE in the NTN by the identity of the satellite. The base station and the UE may determine the satellite participating in transmission of the downlink reference signal and the uplink reference signal according to the identity of the satellite.

In one possible implementation, the identity of the satellite may include an identity of a serving cell covered by a satellite signal.

In one possible implementation, the network device may transmit the ephemeris of the satellite to the UE. The UE may determine a location of the satellite based on the ephemeris of the satellite, and further receive the transmitted downlink reference signal (including the transparently transmitted downlink reference signal), and/or transmit the uplink reference signal (including the transparently transmitted uplink reference signal to the base station via the satellite) to the satellite.

The timing of the satellite may be configured for, but is not limited to, synchronization of the uplink reference signal transmitted to the satellite by the UE.

The configuration of the uplink reference signal may include, but is not limited to, at least one of: a configuration configured for the network device to identify the uplink reference signal; or a resource configuration for transmitting the uplink reference signal between the UE and the network device.

The configuration of the downlink reference signal may include, but is not limited to, at least one of: a configuration configured for the UE to identify the downlink reference signal; or a resource configuration for transmitting the downlink reference signal between the UE and the network device.

In one embodiment, the configuration of the uplink reference signal includes at least one of:
the identity of the uplink reference signal; the sequence of the uplink reference signal; or the transmission resource of the uplink reference signal.

The configuration of the downlink reference signal includes at least one of:
the identity of the downlink reference signal; the sequence of the downlink reference signal; or the transmission resource of the downlink reference signal.

In one possible implementation, the network device may configure identities of a plurality of reference signals (including the uplink reference signal and/or the downlink reference signal). The UE may receive and/or transmit the reference signals according to the identities of the reference signals pre-configured by the network device.

In one possible implementation, the network device may configure a plurality of uplink reference signals. The UE may transmit, according to the configuration of the uplink reference signal pre-configured by the network device, the uplink reference signal to the base station, where the uplink reference signal is transparently transmitted to the base station via the satellite or directly transmitted to a space-borne base station.

The configuration of the uplink reference signal is configured to determine a transmission configuration of an uplink reference signal (UL RS) in a case that the UE performs the uplink reference signal (such as an uplink SRS) transmission, which includes determining a transmission time-frequency position of the uplink reference signal and the sequence of the uplink reference signal. Besides, the configuration information is further configured to determine the identity of the satellite, the timing of the satellite, etc.

In one possible implementation, the network device may configure a plurality of downlink reference signals. The UE may receive, according to the configuration of the downlink reference signal pre-configured by the network device, the downlink reference signal transmitted by the base station, where the downlink reference signal is transparently transmitted to the UE via the satellite or transmitted by the space-borne base station.

Information of the plurality of reference signals (RSs) configured at the network side is obtained, and a target RS used for performing a positioning measurement is determined based on identities of the RSS (RS IDs).

The configuration of the downlink reference signal is configured to determine a measurement configuration for the downlink reference signal in a case that the UE performs a downlink reference signal (such as a downlink PRS) measurement, which includes determining a measurement time-frequency location for measuring the downlink reference signal, the sequence of the downlink reference signal, etc.

In one possible implementation, the configuration information is further configured to indicate a reporting configuration of reporting, by the UE, the measurement result. The reporting configuration here may include a transmission resource for reporting the measurement result.

As shown in FIG. 8, a method for transmitting information is provided in the embodiments of the present disclosure. The method is performed by the network device and includes the following step 801.

In step 801, a configuration request, transmitted by the UE, is received.

The step of transmitting the configuration information to the UE includes: transmitting the configuration information to the UE in response to receiving the configuration request.

The configuration request here may be transmitted based on the request from the UE. The UE may transmit the configuration request to the network device. The network device transmits the configuration information to the UE after receiving the configuration request.

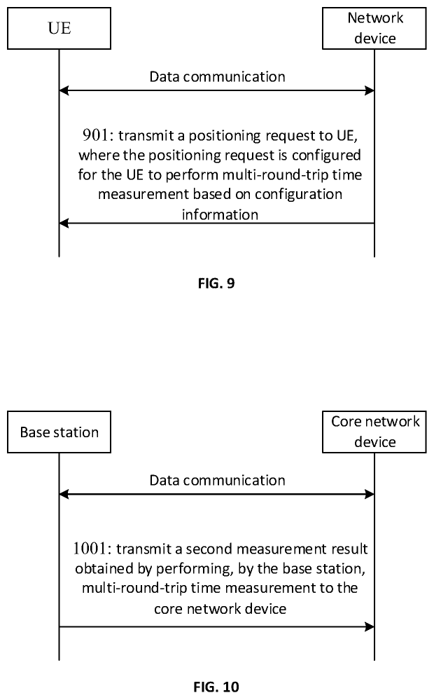

As shown in FIG. 9, a method for transmitting information is provided in the embodiments of the present disclosure. The method is performed by the network device and includes the following step 901.

In step 901, a positioning request is transmitted to the UE, where the positioning request is configured for the UE to perform the multi-round-trip time measurement based on configuration information.

The network device may determine whether to transmit the positioning request to the UE to request the UE to perform the multi-round-trip time measurement.

After receiving the positioning request, the UE may perform the multi-round-trip time measurement based on the configuration information.

In one possible implementation, the UE may transmit the first measurement result obtained by performing the multi-round-trip time measurement to the core network device.

As shown in FIG. 10, a method for transmitting information is provided in the embodiments of the present disclosure. The method is performed by the network device. In a case where the network device is the base station, the method includes the following step 1001.

In step 1001, a second measurement result is transmitted to the core network device, where the second measurement result is obtained by performing, by the base station, the multi-round-trip time measurement.

The base station may perform the multi-round-trip time measurement based on configuration information, and transmit the second measurement result obtained by performing the multi-round-trip time measurement to the core network device.

Illustratively, as shown in FIG. 4, the base station may transmit indication information indicating T2 to the core network device. The UE may transmit indication information indicating T1 to the core network device.

Illustratively, as shown in FIG. 4, the UE may transmit the indication information indicating T1 to the base station. The base station may transmit indication information indicating T2 and T1 to the core network device.

Illustratively, as shown in FIG. 6, the base station may transmit indication information indicating T4 and the indication information indicating T2 to the core network device. The UE may transmit the indication information indicating T1 and indication information indicating T3 to the core network device.

In one possible implementation, the base station may obtain the second measurement result by performing the multi-round-trip time measurement based on the configuration information.

In one possible implementation, in a case where the configuration information is determined by the core network device, the core network device may transmit the configuration information to the base station. The base station obtains the second measurement result by performing the multi-round-trip time measurement based on the received configuration information.

In one possible implementation, in a case where the configuration information is determined by the base station, the base station may obtain the second measurement result by performing the multi-round-trip time measurement based on the configuration information determined by the base station.

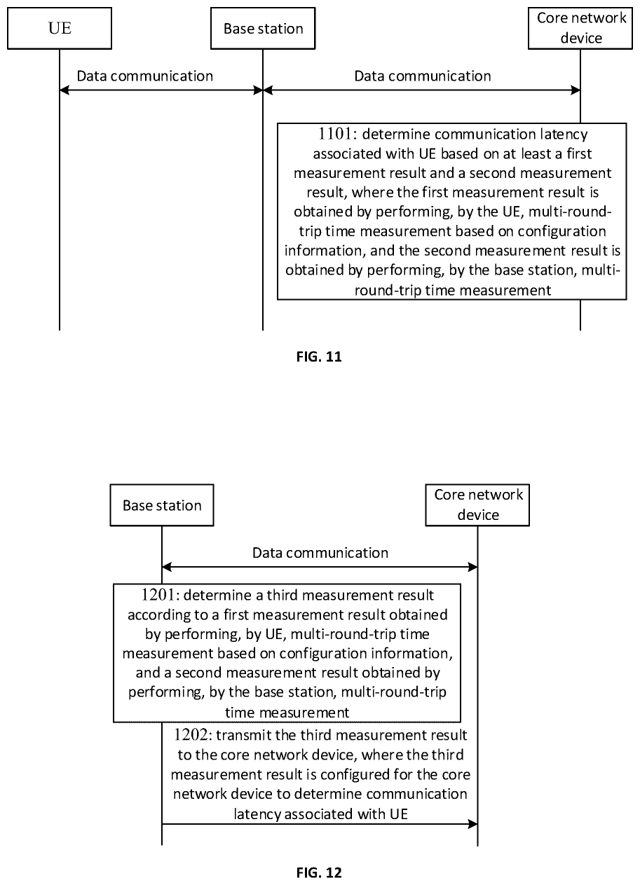

As shown in FIG. 11, a method for transmitting information is provided in the embodiments of the present disclosure. The method is performed by the network device. In a case where the network device is the base station, the method includes the following step 1101.

In step 1101, the communication latency associated with the UE is determined based on at least the first measurement result and the second measurement result, where the first measurement result is obtained by performing, by the UE, the multi-round-trip time measurement based on configuration information, and the second measurement result is obtained by performing, by the base station, the multi-round-trip time measurement.

In one possible implementation, the core network device (such as the LMF) may receive the first measurement result and the second measurement result transmitted by the UE and the base station respectively, where the first measurement result is obtained by performing, by the UE, the multi-round-trip time measurement, and the second measurement result is obtained by performing, by the base station, the multi-round-trip time measurement.

The core network device may determine the communication latency associated with the UE based on the first measurement result and the second measurement result. For example, the core network device may determine round-trip time of the reference signal, i.e. round-trip communication latency of signal between the base station and the UE.

In one possible implementation, one-way communication latency between the UE and the base station is half the round-trip communication latency.

In one possible implementation, the core network device may determine location information of the UE based on the first measurement result and the second measurement result.

For example, the core network device may determine the round-trip time of the reference signal, and determine a relative location between the UE and the base station based on a propagation speed of the reference signal.

The core network may measure the relative location between the base station and the UE repeatedly, and further determine the location information of the UE.

In one possible implementation, the core network device may compare the determined location information of the UE with location information reported by the UE, and determine the accuracy of the location information reported by the UE.

In one embodiment, the first measurement result and the second measurement result are transmitted to the core network device by the UE, where the second measurement result is transmitted to the UE by the base station;
or the first measurement result and the second measurement result are transmitted to the core network device by the base station, where the first measurement result is transmitted to the base station by the UE; or the first measurement result is transmitted to the core network device by the UE, and the second measurement result is transmitted to the core network device by the base station.

The first measurement result and the second measurement result may be reported to the core network device by the UE and the base station respectively, or both the first measurement result and the second measurement result are reported to the core network device by the UE or the base station.

In one possible implementation, after determining the first measurement result, the UE may transmit the first measurement result to the base station. The base station may transmit the first measurement result and the second measurement result determined by the base station to the core network device.

In one possible implementation, after determining the second measurement result, the base station may transmit the second measurement result to the UE. The UE may transmit the second measurement result and the first measurement result determined by the UE to the core network device.

Thus, signaling overhead caused by reporting the measurement results by the UE and the base station can be reduced by reporting the measurement results by the UE or the base station.

In one embodiment, the step of determining the communication latency associated with the UE based on at least the first measurement result and the second measurement result includes: receiving the third measurement result transmitted by the UE or the base station, where the third measurement result is determined by the UE or the base station based on the first measurement result and the second measurement result; and determining the communication latency associated with the UE based on the third measurement result.

Here, partial processing on the first measurement result and the second measurement result, i.e. obtaining the third measurement result according to the first measurement result and the second measurement result, may be performed at the base station or the UE.

Here, obtaining the third measurement result according to the first measurement result and the second measurement result may include, but is not limited to, one of:
obtaining the third measurement result by performing mathematical calculation necessary to determine the communication latency on the first measurement result and the second measurement result, for example, a difference obtained by subtracting the first measurement result from the second measurement result is determined as the third measurement result, or the sum of the second measurement result and the first measurement result is determined as the third measurement result; obtaining the third measurement result by quantizing the first measurement result and the second measurement result; or obtaining the third measurement result by combining the first measurement result and the second measurement result into one information element (IE).

The third measurement result is obtained by processing, by the base station or the UE, the first measurement result and the second measurement result. The transmission latency is determined by the core network device based on the third measurement result obtained after the processing. Thus, a processing load of the core network device can be reduced.

As shown in FIG. 12, a method for transmitting information is provided in the embodiments of the present disclosure. The method is performed by the network device. In a case where the network device is the base station, the method includes the following steps 1201 and 1202.

In step 1201, the third measurement result is determined according to the first measurement result obtained by performing, by the UE, the multi-round-trip time measurement based on the configuration information, and the second measurement result obtained by performing, by the base station, the multi-round-trip time measurement.

In step 1202, the third measurement result is transmitted to the core network device, where the third measurement result is configured for the core network device to determine the communication latency associated with the UE.

Here, partial processing on the first measurement result and the second measurement result, i.e. obtaining the third measurement result according to the first measurement result and the second measurement result, may be performed at the base station.

Here, obtaining, by the base station, the third measurement result according to the first measurement result and the second measurement result may include, but is not limited to, one of: obtaining the third measurement result by performing, by the base station, mathematical calculation necessary to determine the communication latency on the first measurement result and the second measurement result, for example, the difference obtained by subtracting the first measurement result from the second measurement result is determined as the third measurement result, or the sum of the second measurement result and the first measurement result is determined as the third measurement result; obtaining the third measurement result by quantizing, by the base station, the first measurement result and the second measurement result; or obtaining the third measurement result by combining, by the base station, the first measurement result and the second measurement result into one IE. The third measurement result is obtained by processing, by the base station, the first measurement result and the second measurement result. The transmission latency is determined by the core network device based on the third measurement result obtained after the processing. Thus, the processing load of the core network device can be reduced.

In one possible implementation, the base station may receive the first measurement result transmitted by the UE.

In one possible implementation, the UE may receive the second measurement result from the base station to determine the third measurement result in combination with the first measurement result.

In one possible implementation, the third measurement result may be determined by the base station based on the first measurement result and the second measurement result. The UE may transmit the first measurement result to the base station for the base station to determine the third measurement result.

In one possible implementation, the location information reported by the UE is determined by the UE through a GNSS.

Illustratively, as shown in FIG. 4, the multi-round-trip time measurement may include one downlink reference signal and one uplink reference signal. The core network device may determine round-trip time (i.e. the round-trip communication latency) of the reference signal based on T1 (the time interval from reception of the downlink reference signal by the UE to transmission of the uplink reference signal from the UE) and T2 (the time interval from transmission of the downlink reference signal from the base station to reception of the uplink reference signal by the base station).

The multi-round-trip time measurement may include the plurality of downlink reference signals and the plurality of uplink reference signals. As shown in FIG. 6, with the multi-round-trip time measurement including two downlink reference signals and two uplink reference signals as an example, the core network device may determine the round-trip time (i.e. the round-trip communication latency) of the reference signal based on T1 (the time interval from reception of the PRS1 by the UE to transmission of the SRS1 from the UE), T2 (the time interval from reception of the SRS1 by the base station to transmission of the PRS2 from the base station), T3 (the time interval from reception of the PRS2 by the UE to transmission of the SRS2 from the UE), and T4 (the time interval from transmission of the PRS1 from the base station to reception of the SRS2 by the base station). The network device may determine round-trip times of two round trips of the reference signal: RTT1 and RTT2. The plurality of downlink reference signals and the plurality of uplink reference signals may be deduced by analogy, which will not be repeated here.

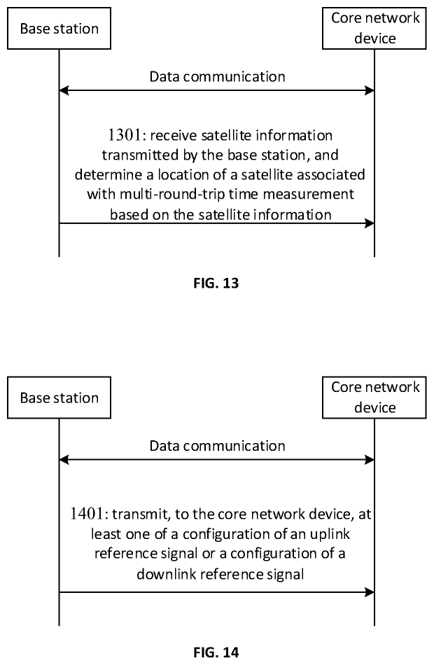

As shown in FIG. 13, a method for transmitting information is provided in the embodiments of the present disclosure. The method is performed by the network device. In a case where the network device is the core network device, the method includes the following step 1301.

In step 1301, satellite information, transmitted by the base station, is received, and the location of the satellite associated with the multi-round-trip time measurement is determined based on the satellite information.

The step of determining the communication latency associated with the UE based on at least the first measurement result and the second measurement result includes: determining, based on the location of the satellite, the first measurement result, and the second measurement result, at least one of: the communication latency between the base station and the UE; the communication latency between the base station and the satellite; or the communication latency between the satellite and the UE.

The satellite information may be configured to indicate the location of the satellite. The satellite information may be configured for the core network device to determine the location of the satellite.

The satellite information may be pre-configured by the NTN.

In one possible implementation, the satellite information includes, but is not limited to, ephemeris information of the satellite.

In one possible implementation, the ephemeris information may indicate at least one of: the operation orbits of the satellite or location information of the satellite at different moments. The core network device may determine, based on the ephemeris information, the location of the satellite during the round-trip time measurement.

The core network device may determine the communication latency between the base station and the UE based on the first measurement result and the second measurement result. A specific method is described above, and is not repeated here.

The core network device may determine the location of the satellite based on the ephemeris information. For the core network device, the ephemeris information is credible. Thus, the core network device may determine a distance between the base station and the satellite, and further determine the communication latency between the base station and the satellite.

The core network device may determine the communication latency between the satellite and the UE based on the communication latency between the base station and the UE and the communication latency between the base station and the satellite.

In one possible implementation, the base station is located on the satellite, and thus the communication latency between the base station and the UE is equal to the communication latency between the satellite and the UE.

As shown in FIG. 14, a method for transmitting information is provided in the embodiments of the present disclosure. The method is performed by the network device. In a case where the network device is the base station, the method includes the following step 1401.

In step 1401, at least one of the following is transmitted to the core network device: the configuration of the uplink reference signal; or the configuration of the downlink reference signal.

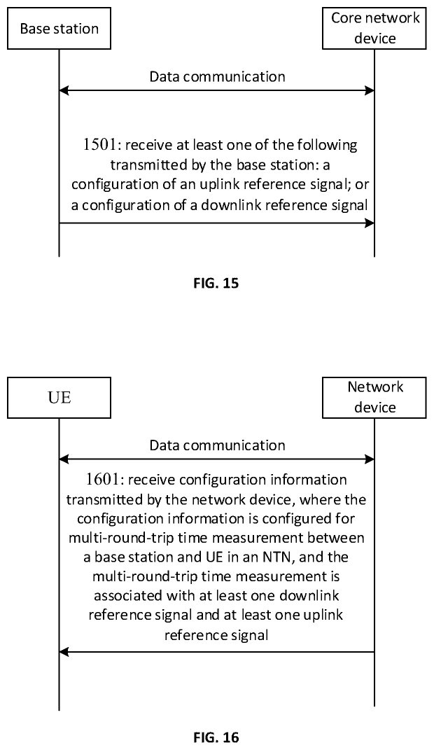

As shown in FIG. 15, a method for transmitting information is provided in the embodiments of the present disclosure. The method is performed by the network device. In a case where the network device is the core network device, the method includes the following step 1501.

In step 1501, at least one of the following, transmitted by the base station, is received: the configuration of the uplink reference signal; or the configuration of the downlink reference signal.

The configuration information here may include the configuration of the uplink reference signal and/or the configuration of the downlink reference signal. The configuration of the uplink reference signal includes at least one of: the identity of the uplink reference signal; the sequence of the uplink reference signal; or the transmission resource of the uplink reference signal. The configuration of the downlink reference signal includes at least one of: the identity of the downlink reference signal; the sequence of the downlink reference signal; or the transmission resource of the downlink reference signal.

In a case where the configuration information is determined by the base station, the base station may transmit the configuration of the uplink reference signal and/or the configuration of the downlink reference signal to the core network device. For example, the base station may transmit the configuration of the uplink reference signal configuration and/or the configuration of the downlink reference signal to an access and mobility management function (AMF) in the core network device.

Based on the configuration of the uplink reference signal and/or the configuration of the downlink reference signal, the core network device may coordinate at least resources of uplink reference signals of different base stations and/or resources of downlink reference signals of different base stations. Thus, mutual interference of the signals can be reduced.

The measurement results reported by the UE and the base station may be identified by the identities of the reference signals. The core network device may determine the identity of the uplink reference signal and/or the identity of the downlink reference signal based on the configuration of the uplink reference signal and/or the configuration of the downlink reference signal, identify the reference signals corresponding to different measurement results, and further determine the communication latency and the location of the UE. Thus, calculation errors resulting from calculations based on incorrect measurement results are reduced.

As shown in FIG. 16, a method for transmitting information is provided in the embodiments of the present disclosure. The method is performed by the user equipment (UE) and includes the following step 1601.

In step 1601, configuration information, transmitted by the network device, is received, where the configuration information is configured for the multi-round-trip time measurement between the base station and the UE in the NTN, and the multi-round-trip time measurement is associated with at least one downlink reference signal and at least one uplink reference signal.

The NTN may include, but is not limited to, one of:
the communication network in which the terrestrial base station communicates with the UE via the satellite serving as a relay; or the communication network in which the satellite, serving as part of the network device (such as the base station) in the mobile communication network, communicates with the UE.

The network device here may include, but is not limited to, at least one of the core network device or the access network device (such as the base station).

The configuration information for the multi-round-trip time measurement may be determined by the core network device or the access network device.

The configuration information may be used to configure the configuration to be involved in the process of the multi-round-trip time measurement between the base station and the UE in the NTN. For example, the configuration information may indicate, but is not limited to, the transmission resource of the downlink reference signal and the transmission resource of the uplink reference signal. Thus, the base station and the UE may transmit the downlink reference signal and the uplink reference signal.

The downlink reference signal may be transmitted to the UE by the access network device. For example, the downlink reference signal may be the PRS.

The uplink reference signal may be transmitted to the access network device by the UE. For example, the uplink reference signal may be the SRS.

In the NTN, the downlink reference signal and the uplink reference signal may be forwarded by the satellite in the NTN.

In one possible implementation, the satellite in the NTN may be in the transparent forwarding mode, i.e. the satellite forwards the downlink reference signal and the uplink reference signal, without performing any decoding operation. As shown in FIG. 4, the downlink reference signal transmitted by the base station is transparently transmitted to the UE via the satellite, and the uplink reference signal transmitted by the UE is transparently transmitted to the base station via the satellite.

In one possible implementation, the satellite may be the serving satellite of the UE. The serving satellite may be the satellite associated with the serving cell of the UE.

In one possible implementation, the multi-round-trip time measurement may include at least one downlink reference signal and at least one uplink reference signal.

As shown in FIG. 4, the multi-round-trip time measurement may include one downlink reference signal and one uplink reference signal. The network device may determine the round-trip time of the reference signal based on T1 (the time interval from reception of the downlink reference signal by the UE to transmission of the uplink reference signal from the UE) and T2 (the time interval from transmission of the downlink reference signal from the base station to reception of the uplink reference signal by the base station).

The multi-round-trip time measurement may include the plurality of downlink reference signals and the plurality of uplink reference signals. As shown in FIG. 6, with the multi-round-trip time measurement including two downlink reference signals and two uplink reference signals as an example, the network device may determine the round-trip time of the reference signal based on T1 (the time interval from reception of the PRS1 by the UE to transmission of the SRS1 from the UE), T2 (the time interval from reception of the SRS1 by the base station to transmission of the PRS2 from the base station), T3 (the time interval from reception of the PRS2 by the UE to transmission of the SRS2 from the UE), and T4 (the time interval from transmission of the PRS1 from the base station to reception of the SRS2 by the base station). The network device may determine round-trip times of two round trips of the reference signal: RTT1 and RTT2. The plurality of downlink reference signals and the plurality of uplink reference signals may be deduced by analogy, which will not be repeated here.

In one possible implementation, the core network device may calculate the round-trip time of the reference signal, and determine the location of the UE.

In one possible implementation, the base station and the UE may report measurement results to the core network device, and the core network device may determine the location of the UE.

In one possible implementation, the UE may report a measurement result to the base station, and the base station may report a measurement result to the core network device. The measurement result may be determined according to the measurement result of the terminal and the measurement result of the base station. The core network device determines the location of the UE.

In one possible implementation, the satellite in the NTN may be or is in the regenerative mode, i.e. the satellite may have some or all functions of the network device, and may process data from the network side or the terminal. For example, the base station may be located on the satellite directly. Thus, the downlink reference signal and the uplink reference signal may be signals transmitted between the satellite and the UE.

In one possible implementation, the network device may configure one or more satellites to participate in the multi-round-trip time measurement between the base station and the UE. The configuration information may be associated with one or more satellites.

The satellite here may be located on different orbits, including, but not limited to, one of: the GEO; the MEO, and the LEO.

The network device may determine the configuration information based on at least one of: the orbital altitude information of the serving satellite; the availability of the transmission resource; the load of the base station; the load of the UE; or the load of the satellite.

In one possible implementation, in a case where the network device is the access network device, the base station may transmit the configuration information to the UE.

In one possible implementation, in a case where the network device is the core network device, the core network device may transmit the configuration information to the UE via the access network device.

The network device determines the configuration information. Thus, the demand for the multi-round-trip time measurement between the base station and the UE in the NTN is satisfied, and a success rate of the multi-round-trip time measurement is increased.

In one embodiment, the configuration information is configured to indicate at least one of: the identity of the satellite associated with the multi-round-trip time measurement; the ephemeris of the satellite; the timing of the satellite; the configuration of the uplink reference signal; the configuration of the downlink reference signal; or the configuration of reporting, by the UE, the first measurement result associated with the multi-round-trip time measurement to the network device.

The identity of the satellite may be configured to uniquely identify the satellite. The configuration information may indicate the satellite participating in the multi-round-trip time measurement between the base station and the UE in the NTN by the identity of the satellite. The base station and the UE may determine the satellite participating in transmission of the downlink reference signal and the uplink reference signal according to the identity of the satellite.

In one possible implementation, the identity of the satellite may include the identity of the serving cell covered by the satellite signal.

In one possible implementation, the network device may transmit the ephemeris of the satellite to the UE. The UE may determine the location of the satellite based on the ephemeris of the satellite, and further receive the transmitted downlink reference signal (including the transparently transmitted downlink reference signal), and/or transmit the uplink reference signal (including the transparently transmitted uplink reference signal to the base station via the satellite) to the satellite.

The timing of the satellite may be configured for, but is not limited to, synchronization of the uplink reference signal transmitted to the satellite by the UE.

The configuration of the uplink reference signal may include, but is not limited to, at least one of: the configuration configured for the network device to identify the uplink reference signal; or the resource configuration for transmitting the uplink reference signal between the UE and the network device.

The configuration of the downlink reference signal may include, but is not limited to, at least one of: the configuration configured for the UE to identify the downlink reference signal; or the resource configuration for transmitting the downlink reference signal between the UE and the network device.

In one embodiment, the configuration of the uplink reference signal includes at least one of:
the identity of the uplink reference signal; the sequence of the uplink reference signal; or the transmission resource of the uplink reference signal.

The configuration of the downlink reference signal includes at least one of:
the identity of the downlink reference signal; the sequence of the downlink reference signal; or the transmission resource of the downlink reference signal.

In one possible implementation, the network device may configure the identities of the plurality of reference signals (including the uplink reference signal and/or the downlink reference signal). The UE may receive and/or transmit the reference signals according to the identities of the reference signals pre-configured by the network device.

In one possible implementation, the network device may configure the plurality of uplink reference signals. The UE may transmit, according to the configuration of the uplink reference signal pre-configured by the network device, the uplink reference signal to the base station, where the uplink reference signal is transparently transmitted to the base station via the satellite or directly transmitted to the space-borne base station.

The configuration of the uplink reference signal is configured to determine the transmission configuration of the UL RS in a case that the UE performs the uplink reference signal (such as the uplink SRS) transmission, which includes determining the transmission time-frequency position of the uplink reference signal and the sequence of the uplink reference signal. Besides, the configuration information is further configured to determine the identity of the satellite, the timing of the satellite, etc.

In one possible implementation, the network device may configure the plurality of downlink reference signals. The UE may receive, according to the configuration of the downlink reference signal pre-configured by the network device, the downlink reference signal transmitted by the base station, where the downlink reference signal is transparently transmitted to the UE via the satellite or transmitted by the space-borne base station.

Information of the plurality of RSs configured at the network side is obtained, and the target RS used for performing the positioning measurement is determined based on the RS IDs.

The configuration of the downlink reference signal is configured to determine the measurement configuration for the downlink reference signal in a case that the UE performs the downlink reference signal (such as the downlink PRS) measurement, which includes determining the measurement time-frequency location for measuring the downlink reference signal, the sequence of the downlink reference signal, etc.

In one possible implementation, the configuration information is further configured to indicate the reporting configuration of reporting, by the UE, the measurement result. The reporting configuration here may include the transmission resource for reporting the measurement result.

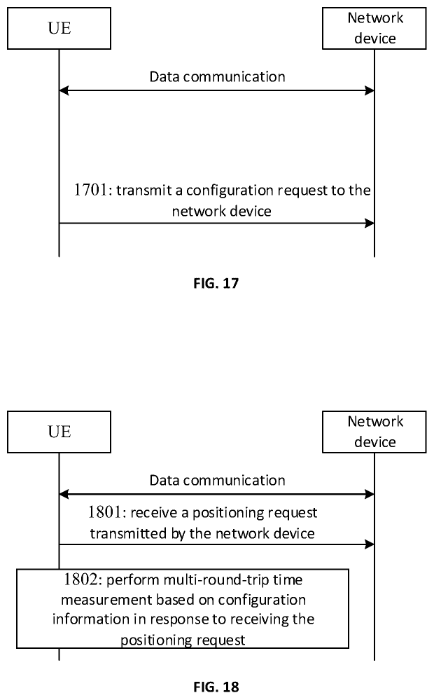

As shown in FIG. 17, a method for transmitting information is provided in the embodiments of the present disclosure. The method is performed by the UE and includes the following step 1701.

In step 1701, the configuration request is transmitted to the network device.

The step of receiving the configuration information transmitted by the network device includes: receiving the configuration information transmitted to the UE by the network device, where the configuration information is transmitted by the network device in response to receiving the configuration request.

The configuration request here may be transmitted based on the request from the UE.

The UE may transmit the configuration request to the network device. The network device transmits the configuration information to the UE after receiving the configuration request.

As shown in FIG. 18, a method for transmitting information is provided in the embodiments of the present disclosure. The method is performed by the UE and includes the following steps 1801 and 1802.

In step 1801, the positioning request, transmitted by the network device, is received.

In step 1802, the multi-round-trip time measurement is performed based on the configuration information in response to receiving the positioning request.

The network device may determine whether to transmit the positioning request to the UE to request the UE to perform the multi-round-trip time measurement.

After receiving the positioning request, the UE may perform the multi-round-trip time measurement based on the configuration information.

In one possible implementation, the UE may transmit the first measurement result obtained by performing the multi-round-trip time measurement to the core network device.

The base station may perform the multi-round-trip time measurement based on the configuration information, and transmit the second measurement result obtained by performing the multi-round-trip time measurement to the core network device.

Illustratively, as shown in FIG. 4, the base station may transmit the indication information indicating T2 to the core network device. The UE may transmit the indication information indicating T1 to the core network device.

Illustratively, as shown in FIG. 4, the UE may transmit the indication information indicating T1 to the base station. The base station may transmit the indication information indicating T2 and T1 to the core network device.

Illustratively, as shown in FIG. 6, the base station may transmit the indication information indicating T4 and the indication information indicating T2 to the core network device. The UE may transmit the indication information indicating T1 and the indication information indicating T3 to the core network device.

In one possible implementation, the base station may obtain the second measurement result by performing the multi-round-trip time measurement based on the configuration information.

In one possible implementation, in a case where the configuration information is determined by the core network device, the core network device may transmit the configuration information to the base station. The base station obtains the second measurement result by performing the multi-round-trip time measurement based on the received configuration information.

In one possible implementation, in a case where the configuration information is determined by the base station, the base station may obtain the second measurement result by performing the multi-round-trip time measurement based on the configuration information determined by the base station.

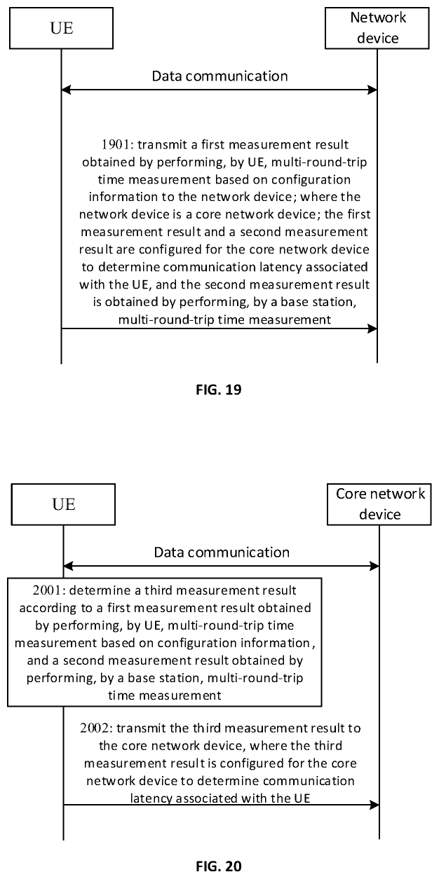

As shown in FIG. 19, a method for transmitting information is provided in the embodiments of the present disclosure. The method is performed by the UE and includes the following step 1901.

In step 1901, the first measurement result obtained by performing, by the UE, the multi-round-trip time measurement based on the configuration information is transmitted to the network device; where the network device is the core network device.

The first measurement result and the second measurement result are configured for the core network device to determine the communication latency associated with the UE, and the second measurement result is obtained by performing, by the base station, the multi-round-trip time measurement.

In one possible implementation, the core network device (such as the LMF) may receive the first measurement result and the second measurement result transmitted by the UE and the base station respectively, where the first measurement result is obtained by performing, by the UE, the multi-round-trip time measurement, and the second measurement result is obtained by performing, by the base station, the multi-round-trip time measurement.

The core network device may determine the communication latency associated with the UE based on the first measurement result and the second measurement result. For example, the core network device may determine the round-trip time of the reference signal, i.e. the round-trip communication latency of the signal between the base station and the UE.

In one possible implementation, the one-way communication latency between the UE and the base station is half the round-trip communication latency.

In one possible implementation, the core network device may determine the location information of the UE based on the first measurement result and the second measurement result.

For example, the core network device may determine the round-trip time of the reference signal, and determine the relative location between the UE and the base station based on the propagation speed of the reference signal.

The core network may measure the relative location between the base station and the UE repeatedly, and further determine the location information of the UE. In one possible implementation, the core network device may compare the determined location information of the UE with the location information reported by the UE, and determine the accuracy of the location information reported by the UE.

In one embodiment, transmitting the first measurement result obtained by performing, by the UE, the multi-round-trip time measurement based on the configuration information to the network device includes one of:
transmitting the first measurement result to the base station, where the first measurement result is transmitted to the core network device by the base station; or receiving the second measurement result transmitted by the base station, and transmitting the first measurement result and the second measurement result to the core network device.

The first measurement result and the second measurement result may be reported to the core network device by the UE and the base station respectively, or both the first measurement result and the second measurement result are reported to the core network device by the UE or the base station.

In one possible implementation, after determining the first measurement result, the UE may transmit the first measurement result to the base station. The base station may transmit the first measurement result and the second measurement result determined by the base station to the core network device.

In one possible implementation, after determining the second measurement result, the base station may transmit the second measurement result to the UE. The UE may transmit the second measurement result and the first measurement result determined by the UE to the core network device.

Thus, signaling overhead caused by reporting the measurement results by the UE and the base station can be reduced by reporting the measurement results by the UE or the base station.

In one possible implementation, the location information reported by the UE is determined by the UE through the GNSS.

Illustratively, as shown in FIG. 4, the multi-round-trip time measurement may include one downlink reference signal and one uplink reference signal. The core network device may determine the round-trip time (i.e. the round-trip communication latency) of the reference signal based on T1 (the time interval from reception of the downlink reference signal by the UE to transmission of the uplink reference signal from the UE) and T2 (the time interval from transmission of the downlink reference signal from the base station to reception of the uplink reference signal by the base station).

The multi-round-trip time measurement may include the plurality of downlink reference signals and the plurality of uplink reference signals. As shown in FIG. 6, with the multi-round-trip time measurement including two downlink reference signals and two uplink reference signals as an example, the core network device may determine the round-trip time (i.e. the round-trip communication latency) of the reference signal based on T1 (the time interval from reception of the PRS1 by the UE to transmission of the SRS1 from the UE), T2 (the time interval from reception of the SRS1 by the base station to transmission of the PRS2 from the base station), T3 (the time interval from reception of the PRS2 by the UE to transmission of the SRS2 from the UE), and T4 (the time interval from transmission of the PRS1 from the base station to reception of the SRS2 by the base station). The network device may determine the round-trip times of two round trips of the reference signal: RTT1 and RTT2. The plurality of downlink reference signals and the plurality of uplink reference signals may be deduced by analogy, which will not be repeated here.

As shown in FIG. 20, a method for transmitting information is provided in the embodiments of the present disclosure. The method is performed by the UE and includes the following steps 2001 and 2002.

In step 2001, the third measurement result is determined according to the first measurement result obtained by performing, by the UE, the multi-round-trip time measurement based on the configuration information, and the second measurement result obtained by performing, by the base station, the multi-round-trip time measurement.

In step 2002, the third measurement result is transmitted to the core network device, where the third measurement result is configured for the core network device to determine the communication latency associated with the UE.

Here, partial processing on the first measurement result and the second measurement result, i.e. obtaining the third measurement result according to the first measurement result and the second measurement result, may be performed at the base station or the UE.

Here, obtaining the third measurement result according to the first measurement result and the second measurement result may include, but is not limited to, one of:
obtaining the third measurement result by performing, by the UE, the mathematical calculation necessary to determine the communication latency on the first measurement result and the second measurement result, for example, the difference obtained by subtracting the first measurement result from the second measurement result is determined as the third measurement result, or the sum of the second measurement result and the first measurement result is determined as the third measurement result; obtaining the third measurement result by quantizing, by the UE, the first measurement result and the second measurement result; or obtaining the third measurement result by combining, by the UE, the first measurement result and the second measurement result into one IE.

The third measurement result is obtained by processing, by the UE, the first measurement result and the second measurement result. The transmission latency is determined by the core network device based on the third measurement result obtained after the processing. Thus, the processing load of the core network device can be reduced.

In one possible implementation, the UE may receive the second measurement result from the base station to determine the third measurement result in combination with the first measurement result.

In one possible implementation, the third measurement result may be determined by the base station based on the first measurement result and the second measurement result. The UE may transmit the first measurement result to the base station for the base station to determine the third measurement result. In one embodiment, the first measurement result, the second measurement result, and the location of the satellite associated with the multi-round-trip time measurement are configured for the core network device to determine at least one of:
the communication latency between the base station and the UE; the communication latency between the base station and the satellite; or the communication latency between the satellite and the UE. Where the location of the satellite is indicated to the core network device by the base station via the satellite information.

The satellite information may be configured to indicate the location of the satellite. The satellite information may be configured for the core network device to determine the location of the satellite.

The satellite information may be pre-configured by the NTN.

In one possible implementation, the satellite information includes, but is not limited to, the ephemeris information of the satellite.

In one possible implementation, the ephemeris information may indicate at least one of: the operation orbits of the satellite or the location information of the satellite at different moments. The core network device may determine, based on the ephemeris information, the location of the satellite during the round-trip time measurement.

The core network device determines the communication latency between the base station and the UE based on the first measurement result and the second measurement result. A specific method is described above, and is not repeated here.

The core network device may determine the location of the satellite based on the ephemeris information. For the core network device, the ephemeris information is credible. Thus, the core network device may determine the distance between the base station and the satellite, and further determine the communication latency between the base station and the satellite.

The core network device may determine the communication latency between the satellite and the UE based on the communication latency between the base station and the UE and the communication latency between the base station and the satellite.

In one possible implementation, the base station is located on the satellite, and thus the communication latency between the base station and the UE is equal to the communication latency between the satellite and the UE.

A specific instance is provided below with reference to any embodiment described above:

1) The base station transmits ephemeris-related information (the ephemeris information) of the satellite, i.e. a target satellite, to the core network device.

The base station may transmit the ephemeris-related information of the target satellite to a related network element such as the LMF in the core network. The ephemeris-related information is related to the operation orbit of the target satellite, such as an altitude, a speed, an operation direction, and a location. After obtaining the ephemeris-related information of the satellite, the core network device may obtain information such as target propagation latency (the communication latency between the base station and the UE, and/or the communication latency between the base station and the satellite, and/or the communication delay between the satellite and the UE).

The target satellite may be one or more satellites. The target satellite is configured to participate in implementation of a positioning operation of a terminal. The target satellite may be located on the GEO, the MEO, or the LEO. The target satellite may be in the transparent forwarding mode (the satellite forwards data from the terminal or the base station only, without performing any decoding operation) or in the regenerative mode (the satellite may have some or all functions of the network device, and process data from the network side or the terminal).

2) Configuration information required by a target terminal to perform the positioning operation is configured.

The configuration information required by the target terminal to perform the positioning operation is configured by the core network device or the base station.

Transmission of the configuration information may be initiated by the core network device or the base station, or a configuration request for the configuration information is initiated by the terminal, and the configuration information is transmitted by the core network device or the base station based on the configuration request.

The configuration information is used for the terminal to obtain the configuration information required to perform positioning measurement-related operations, and includes, but is not limited to the following a-e.

a) Cell ID

It is configured to indicate identity information of the target satellite (the serving cell), and further probably carry the ephemeris information of the target satellite.

b) reference signal identity (RS ID)

The terminal may obtain information of the plurality of reference signals (RSs) configured at the network side in advance, and determine the target RS used for performing the positioning measurement based on the RS ID.

c) measurement configuration information of the downlink reference signal (DL RS)

The configuration information is configured to determine the measurement configuration for a target DL RS in a case that the terminal performs a measurement for the DL RS, such as a DL-PRS, which includes determining a measurement time-frequency location (a transmission resource) for measuring the DL-RS, a sequence of the RS, etc.

d) measurement configuration information of uplink reference signal (DL RS)

The configuration information is configured to determine a transmission configuration for a target UL RS in a case that the terminal performs transmission of the UL RS, such as a UL-SRS, which includes determining a transmission time-frequency location (a transmission resource) for the UL-RS, a sequence of the RS, identity information of a target serving satellite, and timing of the target serving satellite, etc.

e) configuration information of an Rx-Tx time interval (the time interval from transmission of the downlink reference signal from the base station to reception of the uplink reference signal by the base station, and/or the time interval from reception of the downlink reference signal by the UE to transmission of the uplink reference signal from the UE, etc.)

The configuration information is configured for the terminal to determine configuration information for reporting Rx-Tx time information.

3) The base station transmits the configuration information to the AMF.

The configuration information includes, but is not limited to, configuration information for transmitting, by the terminal, the uplink RS, such as a configuration of the UL-SRS.

4) It is determined that the positioning operation needs to be performed.

The network device determines to perform a location verification operation, and initiates the positioning request.

5) The terminal performs a positioning-related operation.

The terminal performs the measurement for the DL-RS based on the configuration information, transmits the UL RS, and reports the Rx-Tx time interval.

6) The network device determines a positioning result.

The core network device receives positioning measurement-related information from the terminal and the base station, and determines the location information of the terminal.

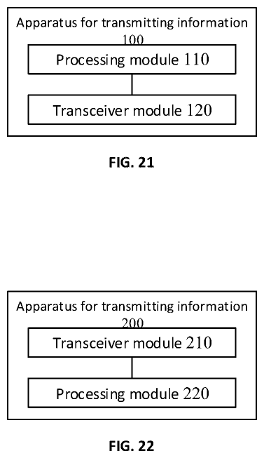

As shown in FIG. 21, an apparatus for transmitting information 100 is provided in the embodiments of the present disclosure. The apparatus is arranged in the network device and includes a processing module 110 and a transceiver module 120.

The processing module 110 is configured to determine configuration information, where the configuration information is configured for the multi-round-trip time measurement between the base station and the UE in the NTN, and the multi-round-trip time measurement is associated with at least one downlink reference signal and at least one uplink reference signal.

The transceiver module 120 is configured to transmit the configuration information to the UE.

In one embodiment, the transceiver module 120 is further configured to receive the configuration request transmitted by the UE.

The transceiver module 120 is specifically configured to transmit the configuration information to the UE by transmitting the configuration information to the UE in response to receiving the configuration request.

In one embodiment, the transceiver module 120 is further configured to:
transmit the positioning request to the UE, where the positioning request is configured for the UE to perform the multi-round-trip time measurement based on the configuration information.

In one embodiment, in a case where the network device is the core network device, the processing module 110 is further configured to determine the communication latency associated with the UE based on at least the first measurement result and the second measurement result, where the first measurement result is obtained by performing, by the UE, the multi-round-trip time measurement based on the configuration information, and the second measurement result is obtained by performing, by the base station, the multi-round-trip time measurement.

In one embodiment, the first measurement result and the second measurement result are transmitted to the core network device by the UE, where the second measurement result is transmitted to the UE by the base station;
or the first measurement result and the second measurement result are transmitted to the core network device by the base station, where the first measurement result is transmitted to the base station by the UE; or the first measurement result is transmitted to the core network device by the UE, and the second measurement result is transmitted to the core network device by the base station.

In one embodiment, the transceiver module 120 is further configured to receive the third measurement result transmitted by the UE or the base station, where the third measurement result is determined by the UE or the base station based on the first measurement result and the second measurement result; and
the processing module 110 is further configured to determine the communication latency associated with the UE based on the third measurement result.

In one embodiment, in a case where the network device is the base station,
the processing module 110 is further configured to determine the third measurement result according to the first measurement result obtained by performing, by the UE, the multi-round-trip time measurement based on the configuration information, and the second measurement result obtained by performing, by the base station, the multi-round-trip time measurement; and the transceiver module 120 is further configured to transmit the third measurement result to the core network device, where the third measurement result is configured for the core network device to determine the communication latency associated with the UE.

In one embodiment, the transceiver module 120 is further configured to
receive the satellite information transmitted by the base station, and determine the location of the satellite associated with the multi-round-trip time measurement based on the satellite information. Further, the processing module 110 is specifically configured to: determine, based on the location of the satellite, the first measurement result, and the second measurement result, at least one of: the communication latency between the base station and the UE; the communication latency between the base station and the satellite; or the communication latency between the satellite and the UE.

In one embodiment, in a case where the network device is the base station, the transceiver module 120 is further configured to
transmit the second measurement result obtained by performing, by the base station, the multi-round-trip time measurement to the core network device.

In one embodiment, in a case where the network device is the base station, the transceiver module 120 is further configured to:
transmit, to the core network device, at least one of: the configuration of the uplink reference signal; or the configuration of the downlink reference signal.

In one embodiment, in a case where the network device is the core network device, the transceiver module 120 is further configured to:
receive at least one of the following transmitted by the base station: the configuration of the uplink reference signal; or the configuration of the downlink reference signal.

In one embodiment, the configuration information is configured to indicate at least one of:
the identity of the satellite associated with the multi-round-trip time measurement; the ephemeris of the satellite; the timing of the satellite; the configuration of the uplink reference signal; the configuration of the downlink reference signal; or the configuration of reporting, by the UE, the first measurement result associated with the multi-round-trip time measurement to the network device.

In one embodiment, the configuration of the uplink reference signal includes at least one of:
the identity of the uplink reference signal; the sequence of the uplink reference signal; or the transmission resource of the uplink reference signal.

The configuration of the downlink reference signal includes at least one of:
the identity of the downlink reference signal; the sequence of the downlink reference signal; or the transmission resource of the downlink reference signal.

As shown in FIG. 22, an apparatus for transmitting information 200 is provided in the embodiments of the present disclosure. The apparatus is arranged in the UE and includes a transceiver module 210 and a processing module 220.

The transceiver module 210 is configured to receive configuration information transmitted by the network device, where the configuration information is configured for the multi-round-trip time measurement between the base station and the UE in the NTN, and the multi-round-trip time measurement is associated with at least one downlink reference signal and at least one uplink reference signal.

In one embodiment, the transceiver module 210 is further configured to transmit the configuration request to the network device.

The transceiver module 210 is specifically configured to receive the configuration information transmitted to the UE by the network device, where the configuration information is transmitted by the network device in response to receiving the configuration request.

In one embodiment, the transceiver module 210 is further configured to receive the positioning request transmitted by the network device; and
the processing module 220 is configured to perform the multi-round-trip time measurement based on the configuration information in response to receiving the positioning request.

In one embodiment, the transceiver module 210 is further configured to:
transmit the first measurement result obtained by performing, by the UE, the multi-round-trip time measurement based on the configuration information to the network device; where the network device is the core network device; and the first measurement result and the second measurement result are configured for the core network device to determine the communication latency associated with the UE, and the second measurement result is obtained by performing, by the base station, the multi-round-trip time measurement.

In one embodiment, transmitting the first measurement result obtained by performing, by the UE, the multi-round-trip time measurement based on the configuration information to the network device includes one of:
transmitting the first measurement result to the base station, where the first measurement result is transmitted to the core network device by the base station; or receiving the second measurement result transmitted by the base station, and transmitting the first measurement result and the second measurement result to the core network device.

In one embodiment, the processing module 220 is further configured to determine the third measurement result according to the first measurement result obtained by performing, by the UE, the multi-round-trip time measurement based on the configuration information, and the second measurement result obtained by performing, by the base station, the multi-round-trip time measurement. Additionally,
the transceiver module 210 is further configured to transmit the third measurement result to the core network device, where the third measurement result is configured for the core network device to determine the communication latency associated with the UE. In one embodiment, the first measurement result, the second measurement result, and the location of the satellite associated with the multi-round-trip time measurement are configured for the core network device to determine at least one of: the communication latency between the base station and the UE; the communication latency between the base station and the satellite; or the communication latency between the satellite and the UE; where the location of the satellite is indicated to the core network device by the base station via the satellite information.

In one embodiment, the configuration information is configured to indicate at least one of: the identity of the satellite associated with the multi-round-trip time measurement; the ephemeris of the satellite; the timing of the satellite; the configuration of the uplink reference signal; the configuration of the downlink reference signal; or the configuration of reporting, by the UE, the first measurement result associated with the multi-round-trip time measurement to the network device.

In one embodiment, the configuration of the uplink reference signal includes at least one of:
the identity of the uplink reference signal; the sequence of the uplink reference signal; or the transmission resource of the uplink reference signal.

The configuration of the downlink reference signal includes at least one of:
the identity of the downlink reference signal; the sequence of the downlink reference signal; or the transmission resource of the downlink reference signal.

A communication device is provided in the embodiments of the present disclosure. The communication device includes:
a memory configured to store processor-executable instructions; and one or more processors connected to the memory separately; where the processors are configured to perform the method for transmitting information according to any foregoing technical solution.

The processors may include various types of storage media. The storage media are non-transitory computer storage media that can continue storing information stored in it after the communication device is powered off.

The communication device here includes: UE or a network element, where the network element may be any one of the foregoing first network element to fourth network element.

The processor may be connected to the memory via a bus, etc., and configured to read an executable program stored in the memory, for example, at least one of the methods shown in FIGS. 5-20.

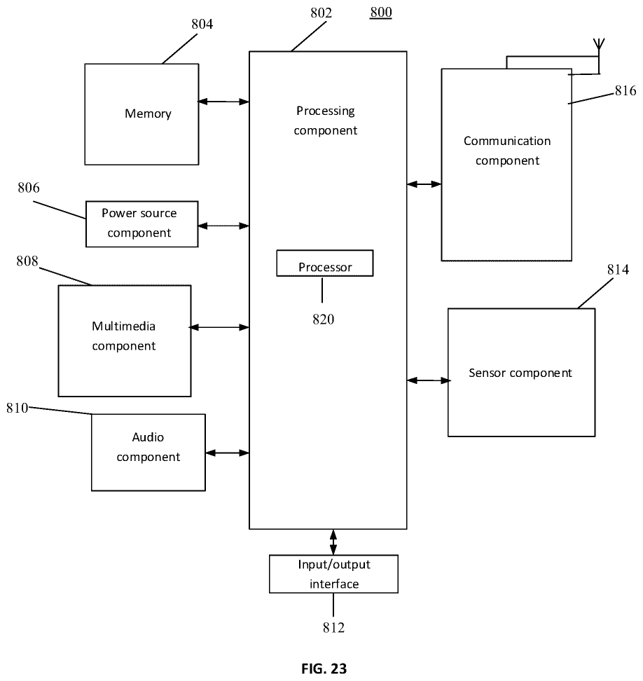

FIG. 23 is a block diagram of UE 800 shown according to an example. For example, the UE 800 may be a mobile phone, a computer, digital broadcast user equipment, a message transceiving device, a gaming console, a tablet device, a medical device, a fitness device, a personal digital assistant, etc.

With reference to FIG. 23, the UE 800 may include one or more of the following components: a processing component 802, a memory 804, a power source component 806, a multimedia component 808, an audio component 810, an input/output (I/O) interface 812, a sensor component 814, and a communication component 816.

Typically, the processing component 802 controls an overall operation of the UE 800, such as operations associated with display, telephone calls, data communication, a camera operation, and a recording operation. The processing component 802 may include one or more processors 820 to execute instructions, so as to generate all or some steps of the above method. In addition, the processing component 802 may include one or more modules, so as to facilitate interactions between the processing component 802 and other components. For example, the processing component 802 may include a multimedia module, so as to facilitate an interaction between the multimedia component 808 and the processing component 802.

The memory 804 is configured to store various types of data to support the operations at the UE 800. Instances of these data include instructions of any application or method operated on the UE 800, contact data, phonebook data, messages, pictures, videos, etc. The memory 804 may be implemented through any type of volatile or non-volatile storage devices or their combinations, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, and an optical disk.

The power source component 806 provides power for various components of the UE 800. The power source component 806 may include a power source management system, one or more power sources, and other components associated with power generation, management, and distribution for the UE 800.

The multimedia component 808 includes a screen that provides an output interface between the UE 800 and a user. In some embodiments, the screen may include a liquid crystal display (LCD) and a touch panel (TP). If the screen includes the touch panel, the screen may be implemented as a touch screen, so as to receive an input signal from the user. The touch panel includes one or more touch sensors, so as to sense touches, swipes, and gestures on the touch panel. The touch sensor may sense a boundary of a touch or swipe action, and measure duration and pressure associated with the touch or swipe operation. In some embodiments, the multimedia component 808 includes one front-facing camera and/or one rear-facing camera. The front-facing camera and/or the rear-facing camera may receive external multimedia data, in a case where the UE 800 is in an operation mode, such as a photographing mode or a video mode. Each of the front-facing camera and the rear-facing camera may be one fixed optical lens system or have a focal length and an optical zoom capability.

The audio assembly 810 is configured to output and/or input an audio signal. For example, the audio component 810 includes a microphone (MIC) that is configured to receive external audio signals, in a case where the UE 800 is in the operation mode, such as a call mode, a recording mode, and a voice recognition mode. The audio signals received may be further stored in the memory 804 or transmitted via the communication component 816. In some embodiments, the audio assembly 810 further includes a speaker configured to output an audio signal.

The I/O interface 812 provides an interface between the processing component 802 and a peripheral interface module. The peripheral interface module may be a keyboard, a click wheel, a button, etc. These buttons may include, but are not limited to, a home button, a volume button, a start button, and a lock button.

The sensor component 814 includes one or more sensors configured to provide state assessments for various aspects of the UE 800. For example, the sensor component 814 may detect an on/off state of the UE 800 and relative positioning of the components. For example, the components are a display and a keypad of the UE 800. The sensor component 814 may further detect a change in position of the UE 800 or one component of the UE 800, presence or absence of contact between the user and the UE 800, orientation or acceleration/deceleration of the UE 800, and a change in temperature of the UE 800. The sensor component 814 may include a proximity sensor configured to detect presence of nearby objects in the absence of any physical contact. The sensor component 814 may further include an optical sensor, such as a complementary metal-oxide-semiconductor transistor (CMOS) or charge coupled device (CCD) image sensor configured to be used in imaging application. In some embodiments, the sensor component 814 may further include an acceleration sensor, a gyroscope sensor, a magnetic sensor, a pressure sensor, or a temperature sensor.

The communication component 816 is configured to facilitate wired or wireless communication between the UE 800 and other devices. The UE 800 may access a wireless network based on a communication standard, for example, a wireless fidelity (WiFi) network, a 2nd generation (2G) network or 3rd generation (3G) network, or their combinations. In one example, the communication component 816 receives a broadcast signal or broadcast-related information from an external broadcast management system via a broadcast channel. In one example, the communication component 816 further includes a near-field communication (NFC) module, so as to facilitate short-range communication. For example, the NFC module may be implemented based on a radio frequency identification (RFID) technology, an infrared data association (IrDA) technology, an ultra-wideband (UWB) technology, a Bluetooth (BT) technology, etc. The transceiver modules 120 and 210 may be any form of the communication component, such as that described with reference to FIG. 23.

In an example, the UE 800 may be configured to perform the above method by being implemented by one or more application-specific integrated circuits (ASICs), digital signal processors (DSPs), digital signal processing devices (DSPDs), programmable logic devices (PLDs), field-programmable gate array (FPGAs), controllers, microcontrollers, microprocessors, etc.

A non-transitory computer-readable storage medium including instructions, such as a memory 804 including instructions, is further provided in an example, where the above instructions may generate the above methods by being executed by a processor 820 of the UE 800. For example, the non-transitory computer-readable storage medium may be an ROM, a random access memory (RAM), a compact disk read-only memory (CD-ROM), a magnetic tape, a floppy disk, an optical data storage device, etc.

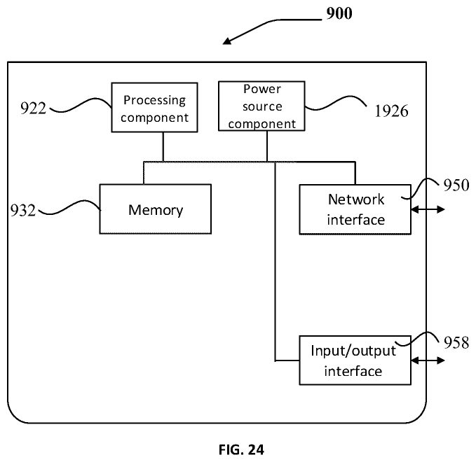

As shown in FIG. 24, a structure of an access device according to an embodiment of the present disclosure is shown in FIG. 24. For example, a communication device 900 may be provided as one network device. The communication device may be various network elements such as the aforementioned access network element(s) and/or network function(s).

With reference to FIG. 24, the communication device 900 includes a processing component 922, and further includes one or more processors and memory resources represented by a memory 932 and configured to store instructions executable by the processing component 922, for example, an application. The application stored in the memory 932 may include one or more modules, each of which corresponds to a set of instructions. In addition, the processing component 922 is configured to execute the instructions, so as to perform the above method, for example, the method shown in any one of FIGS. 5-20.

The communication device 900 may further include one power source component 1926 configured to implement power source management of the communication device 900, one wired or wireless network interface 950 configured to connect the communication device 900 to a network, and one input/output (I/O) interface 958. The communication device 900 may operate based on an operating system stored in the memory 932, such as Windows Server™, Mac OS X™, Unix™, Linux™, and FreeBSD™.

In the case of no contradiction, each step in one implementation or embodiment can be implemented as an independent embodiment, and the steps can be randomly combined. For example, a solution obtained after some steps are removed from one implementation or embodiment can alternatively be implemented as an independent embodiment, and the sequences of the steps in one implementation or embodiment can be randomly exchanged. Also, the optional modes or optional examples in one implementation or embodiment can be randomly combined. In addition, all the implementations or embodiments can be randomly combined. For example, some or all steps in different implementations or embodiments can be randomly combined, and one implementation or embodiment can be randomly combined with optional modes or optional examples in other implementations or embodiments.

Those skilled in the art will readily conceive of other implementations of the present disclosure after consideration of the description and practice of the invention disclosed here. The present disclosure is intended to cover any variations, uses, or adaptive changes of the present disclosure. These variations, uses, or adaptive changes follow the general principles of the present disclosure and include common general knowledge or customary technical means in the art not disclosed in the present disclosure. The description and the embodiments are merely deemed illustrative, and the true scope and spirit of the present disclosure are indicated by the following claims.

It should be understood that the present disclosure is not limited to the precise structures that have been described above and shown in the accompanying drawings, and that various modifications and changes can be made without departing from the scope of the present disclosure. The scope of the present disclosure is merely limited by the appended claims.

1. A method for transmitting information, performed by a network device, comprising:
determining configuration information, wherein the configuration information is configured for multi-round-trip time measurement between a base station and a user equipment (UE) in a non-terrestrial network (NTN), and the multi-round-trip time measurement is associated with at least one downlink reference signal and at least one uplink reference signal.

2. The method according to claim 1, further comprising:
receiving a configuration request transmitted by the UE; and
transmitting the configuration information to the UE in response to receiving the configuration request.

3. (canceled)

4. The method according to claim 2, further comprising:
transmitting a positioning request to the UE, wherein the positioning request is configured for the UE to perform the multi-round-trip time measurement based on the configuration information.

5. The method according to claim 1, wherein the network device is a core network device, and the method further comprises:
determining communication latency associated with the UE based on at least a first measurement result and a second measurement result,
wherein the first measurement result is obtained by performing, by the UE, the multi-round-trip time measurement based on the configuration information, and
wherein the second measurement result is obtained by performing, by the base station, the multi-round-trip time measurement.

6. The method according to claim 5, wherein
the first measurement result and the second measurement result are transmitted to the core network device by the UE, wherein the second measurement result is transmitted to the UE by the base station;
or
the first measurement result and the second measurement result are transmitted to the core network device by the base station, wherein the first measurement result is transmitted to the base station by the UE;
or
the first measurement result is transmitted to the core network device by the UE, and the second measurement result is transmitted to the core network device by the base station.

7. The method according to claim 5, wherein determining the communication latency associated with the UE based on at least the first measurement result and the second measurement result comprises:
receiving a third measurement result transmitted by the UE or the base station, wherein the third measurement result is determined by the UE or the base station based on the first measurement result and the second measurement result; and
determining the communication latency associated with the UE based on the third measurement result.

8. The method according to claim 7, wherein the network device is the base station, and the method further comprises:
determining the third measurement result according to the first measurement result obtained by performing, by the UE, the multi-round-trip time measurement based on the configuration information, and the second measurement result obtained by performing, by the base station, the multi-round-trip time measurement; and
transmitting the third measurement result to the core network device, wherein the third measurement result is configured for the core network device to determine the communication latency associated with the UE.

9. (canceled)

10. The method according to claim 1, wherein in a case where the network device is the base station, the method further comprises at least one of:
transmitting a second measurement result obtained by performing, by the base station, the multi-round-trip time measurement to a core network device; or
transmitting, to the core network device, at least one of: a configuration of the at least one uplink reference signal or a configuration of the at least one downlink reference signal.

11. (canceled)

12. The method according to claim 1, wherein the network device is a core network device, and the method further comprises:
receiving at least one of the following transmitted by the base station: a configuration of the at least one uplink reference signal; or a configuration of the at least one downlink reference signal.

13. The method according to claim 1, wherein the configuration information is configured to indicate at least one of:
an identity of a satellite associated with the multi-round-trip time measurement;
an ephemeris of the satellite;
timing of the satellite;
a configuration of the uplink reference signal;
a configuration of the downlink reference signal; or
a configuration of reporting, by the UE, a first measurement result associated with the multi-round-trip time measurement to the network device.

14. (canceled)

15. A method for transmitting information, performed by a user equipment (UE), comprising:
receiving configuration information transmitted by a network device, wherein the configuration information is configured for multi-round-trip time measurement between a base station and the UE in a non-terrestrial network (NTN), and the multi-round-trip time measurement is associated with at least one downlink reference signal and at least one uplink reference signal.

16. The method according to claim 15, further comprising:
transmitting a configuration request to the network device;, and
wherein receiving the configuration information transmitted by the network device comprises:
receiving the configuration information transmitted to the UE by the network device, wherein the configuration information is transmitted by the network device in response to receiving the configuration request,
receiving a positioning request transmitted by the network device, and
performing the multi-round-trip time measurement based on the configuration information in response to receiving the positioning request.

17. (canceled)

18. The method according to claim 15, further comprising:
transmitting a first measurement result obtained by performing, by the UE, the multi-round-trip time measurement based on the configuration information to the network device,
wherein the network device is a core network device,
wherein the first measurement result and a second measurement result are configured for the core network device to determine communication latency associated with the UE, and
wherein the second measurement result is obtained by performing, by the base station, the multi-round-trip time measurement.

19. The method according to claim 18, wherein transmitting the first measurement result obtained by performing, by the UE, the multi-round-trip time measurement based on the configuration information to the network device comprises one of:
transmitting the first measurement result to the base station, wherein the first measurement result is transmitted to the core network device by the base station; or
receiving the second measurement result transmitted by the base station, and transmitting the first measurement result and the second measurement result to the core network device.

20. The method according to claim 15, further comprising:
determining a third measurement result according to a first measurement result obtained by performing, by the UE, the multi-round-trip time measurement based on the configuration information, and a second measurement result obtained by performing, by the base station, the multi-round-trip time measurement; and
transmitting the third measurement result to a core network device, wherein the third measurement result is configured for the core network device to determine communication latency associated with the UE.

21. (canceled)

22. The method according to claim 15, wherein the configuration information is configured to indicate at least one of:
an identity of a satellite associated with the multi-round-trip time measurement;
an ephemeris of the satellite;
timing of the satellite;
a configuration of the uplink reference signal;
a configuration of the downlink reference signal; or
a configuration of reporting, by the UE, the first measurement result associated with the multi-round-trip time measurement to the network device.

23-25. (canceled)

26. A network device, comprising:
a processor;
a transceiver; and
a memory storing an executable program, and
wherein the processor, when executing the executable program, performs the method for transmitting information according to claim 1.

27. A non-transitory computer-readable storage medium, storing an executable program, wherein the executable program, being executed by a processor, causes the processor to implements the method for transmitting information according to claim 1.

28. A user equipment (UE), comprising:
a processor;
a transceiver; and
a memory storing an executable program,
wherein the processor, when executing the executable program, performs:
receiving configuration information transmitted by a network device, wherein the configuration information is configured for multi-round-trip time measurement between a base station and the UE in a non-terrestrial network (NTN), and the multi-round-trip time measurement is associated with at least one downlink reference signal and at least one uplink reference signal.

29. A non-transitory computer-readable storage medium, storing an executable program, wherein the executable program, being executed by a processor, causes the processor to implement the method for transmitting information according to claim 15.
